(19) United States
(12) Patent Application Publication
(10) Pub. No.: US 2019/0130153 A1
(43) Pub. Date: May 2, 2019

(54) HANDHELD ELECTRONIC DEVICE

(71) Applicant: HUAWEI TECHNOLOGIES CO., LTD., Shenzhen (CN)

(72) Inventors: Jiafu HU, Shenzhen (CN); Jun YANG, Wuhan (CN); Xiaokun WANG, Wuhan (CN); Huabing CHEN, Wuhan (CN)

(21) Appl. No.: 16/095,373

(22) PCT Filed: Apr. 21, 2016
(86) PCT No.: PCT/CN2016/079878

§ 371 Date: Oct. 21, 2018

(51) Int. Cl. G06K 9/00; G06F 21/32; G06F 3/044; G06K 9/62; H05K 5/06; H04M 1/02

(52) U.S. Cl. CPC G06K 9/0002; G06F 21/32; H04M 1/026; G06K 9/62; H05K 5/06; G06F 3/044

(57) ABSTRACT

The present invention discloses a handheld electronic device, including a cover, a fingerprint sensor, and a light emitting unit. The fingerprint sensor and the light emitting unit are disposed inside the handheld electronic device. The cover includes a light transmitting area. The light emitting unit is disposed opposite to the cover and is adjacent to the fingerprint sensor, so that the light emitting unit can emit light through the light transmitting area, so as to indicate a location of an ultrasonic fingerprint sensor. The handheld electronic device disclosed in the present invention has better water-proof performance and dirt-repellent performance.

### TECHNICAL FIELD

The present invention relates to electronic devices, and in particular, to a handheld electronic device.

### BACKGROUND

With popularization of a fingerprint recognition technology, many electronic products are equipped with a fingerprint sensor. The fingerprint sensor is a sensor that can collect a fingerprint and perform fingerprint recognition, for example, an optical fingerprint sensor or a semiconductor fingerprint sensor. Because a volume of an optical fingerprint sensor is relatively large, a handheld electronic device (such as a mobile phone or a tablet computer) usually uses a semiconductor fingerprint sensor to perform fingerprint recognition.

In an existing design, a through hole is disposed on a surface of the handheld electronic device, and the semiconductor fingerprint sensor communicates with an external environment by using the through hole. When a finger touches the semiconductor fingerprint sensor, the semiconductor fingerprint sensor may read a fingerprint and compare the read fingerprint with a pre-stored fingerprint, so as to implement fingerprint recognition.

In a using process, when there is sweat or dirt on the finger, the semiconductor fingerprint sensor has difficulty collecting the fingerprint correctly. If water spatters the through hole, it is easy for the water to get into the electronic device through a gap between the fingerprint sensor and a cover, thereby causing damage to the electronic device and a poor water-proof effect.

### SUMMARY

This application provides a handheld electronic device, which has a better fingerprint recognition capability and water-proof performance.

A first aspect of this application provides a handheld electronic device, including a cover, a fingerprint sensor, and a light emitting unit, where the fingerprint sensor and the light emitting unit are disposed inside the handheld electronic device; the cover includes a light transmitting area; and the light emitting unit is disposed opposite to the cover and is adjacent to the fingerprint sensor, so that the light emitting unit can emit light through the light transmitting area, so as to indicate a location of the fingerprint sensor. The light emitting unit is adjacent to the fingerprint sensor. When the light emitting unit emits light, the location of the fingerprint sensor may be indicated. In addition, the cover separates the fingerprint sensor from the external environment, so as to resolve a water entry problem caused by disposing the through hole on the cover, and improve water-proof performance of the handheld electronic device.

In another possible design, the light emitting unit includes at least one LED, a light guide structure is disposed between the light transmitting area and the light emitting unit, and the light guide structure includes a light inlet disposed opposite to the at least one LED. The light guide structure can evenly guide the light out, so as to improve a display effect.

In another possible design, a material of the light guide structure is polymethyl methacrylate or polycarbonate.

In another possible design, a light filter layer is disposed between the light transmitting area and the light guide structure. The light filter layer may absorb light of a specific wavelength, so as to further improve the display effect.

In another possible design, the light guide structure is a light guide layer, and an internal surface of the light transmitting area is coated with the light guide layer.

In another possible design, the light guide structure is a light guide sheet, and the light guide sheet fits an internal surface of the light transmitting area.

In another possible design, a groove is disposed on the internal surface of the light transmitting area, and the light guide sheet is adhered to a bottom of the groove by using an adhesive.

In another possible design, the fingerprint sensor is an ultrasonic fingerprint sensor, a capacitive fingerprint sensor, or a radio frequency fingerprint sensor.

In another possible design, the cover is a glass cover, a sapphire cover, or a plastic cover.

In another possible design, the light transmitting area is printed with a pattern or a character.

In the handheld electronic device provided in this application, the light emitting unit is adjacent to the fingerprint sensor, and when the light emitting unit emits the light, the location of the fingerprint sensor may be indicated. In addition, the cover separates the fingerprint sensor from the external environment, so as to resolve the water entry problem caused by disposing the through hole on the cover, and improve the water-proof performance of the handheld electronic device.

### BRIEF DESCRIPTION OF DRAWINGS

FIG. 1 is a schematic diagram of an existing handheld electronic device;

FIG. 2 is another schematic diagram of an existing handheld electronic device;

FIG. 3 is a schematic diagram of a handheld electronic device according to an embodiment of the present invention;

FIG. 4 is another schematic diagram of a handheld electronic device according to an embodiment of the present invention;

FIG. 5 is another schematic diagram of a handheld electronic device according to an embodiment of the present invention; and

FIG. 6 is another schematic diagram of a handheld electronic device according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by a person skilled in the art based on the embodiments of the present invention without creative efforts shall fall within the protection scope of the present invention.

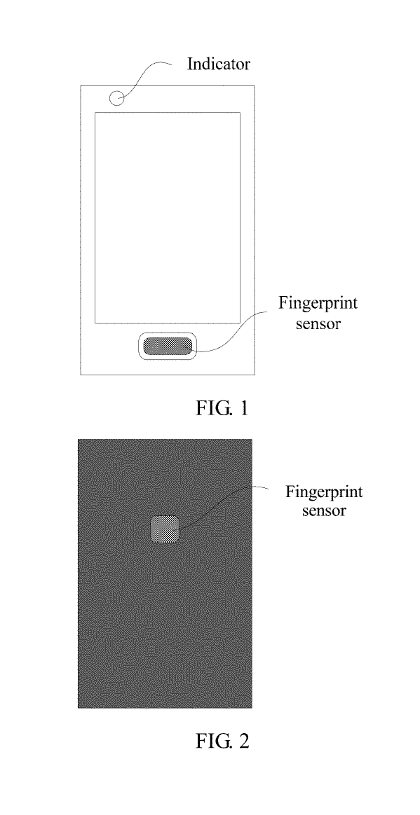

Designs of an existing handheld electronic device are generally divided into two types. In a first design, as shown in FIG. 1, the handheld electronic device includes a combination of a semiconductor fingerprint sensor and a physical button (such as a home button of a mobile phone). In a second design, as shown in FIG. 2, a through hole is disposed on a rear cover of the handheld electronic device, so that the semiconductor fingerprint sensor communicates with an external environment. A semiconductor fingerprint sensor is easily affected by dirt on a finger, and therefore, cannot recognize a fingerprint. In the foregoing two designs, a through hole needs to be disposed on a surface of each of the handheld electronic devices, thereby causing poor water-proof performance.

To resolve the foregoing problem, this application provides a new handheld electronic device, and an embodiment of the handheld electronic device in this application includes:

a cover 10, a fingerprint sensor 20, and a light emitting unit 30, where the fingerprint sensor 20 and the light emitting unit 30 are disposed inside the handheld electronic device.

The cover 10 includes a light transmitting area 101.

The light emitting unit 30 is disposed opposite to the cover 10 and is adjacent to the fingerprint sensor 20, so that the light emitting unit 30 can emit light through the light transmitting area 101 of the cover 10, so as to indicate a location of the fingerprint sensor 20. In this embodiment, the cover 10 may be made of a transparent material such as glass, sapphire, or plastic. Generally, the cover 10 includes a light transmitting area 101 and a light shielding area. The light transmitting area is an area, which light can penetrate, of the cover. The light shielding area surrounds the light transmitting area 101. The light shielding area is an area, which no light can penetrate, of the cover. A principle of the light shielding area is coating the cover with a light shielding ink to prevent light from penetrating the light shielding area. The light shielding ink may be a black ink, a white ink, or an ink of another color. It may be understood that, in a few cases, the cover 10 may be designed as a fully transparent cover.

The fingerprint sensor 20 is a non-contact fingerprint sensor, for example, an ultrasonic fingerprint sensor, a capacitive fingerprint sensor, and a radio frequency fingerprint sensor. The non-contact fingerprint sensor is a fingerprint sensor that can recognize a fingerprint without the need of direct contact with a user finger.

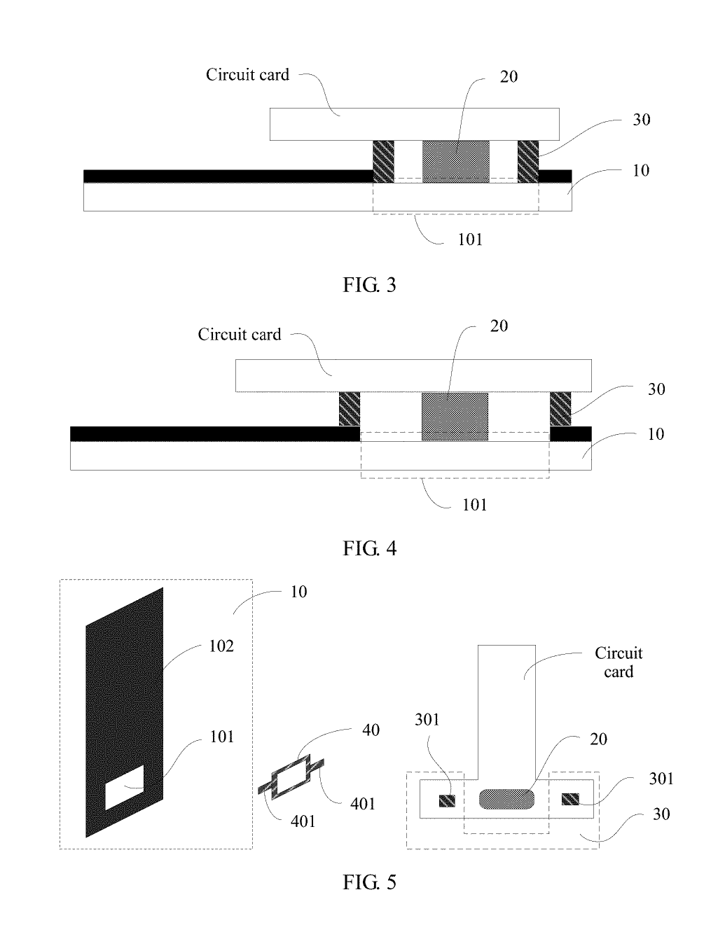

It should be noted that, that the light emitting unit 30 is disposed opposite to the cover 10 may include two cases. In a first case, as shown in FIG. 3, the light emitting unit 30 includes at least one light emitting diode (Light Emitting Diode, LED for short), and the LED may be disposed opposite to the light transmitting area 101. When the LED emits light, the LED may directly emit light through the light transmitting area 101, and the user may directly observe the LED. In a second case, as shown in FIG. 4, the LED may be disposed opposite to a surrounding cover of the light transmitting area 101. When the LED emits light, the LED may emit light through the light transmitting area 101 by means of refraction or reflection. If a thickness of the cover 10 exceeds a side length of the LED, a blind hole that accommodates the LED may be disposed on the cover.

Optionally, both the fingerprint sensor 20 and the light emitting unit 30 are disposed on a circuit card inside the electronic device. In the prior art, a blind hole that accommodates the fingerprint sensor is disposed on the cover 10. In this application, no blind hole needs to be disposed on the cover. Therefore, the cover in this application is more rigid and less fragile compared with that in the prior art. The circuit card may be a printed circuit board (Printed Circuit Board, PCB for short), a flexible printed circuit board (Flexible Printed Circuit Board, FPC for short), or the like. The circuit card may include a single card or multiple cards. The circuit card may be designed according to a practical situation, and is not specifically limited herein.

An ultrasonic fingerprint sensor is used as an example for the fingerprint sensor 20. When the user puts the finger on the light transmitting area 101, the ultrasonic fingerprint sensor 20 may, through the cover 10, scan dermis of the finger, read the user fingerprint, and perform fingerprint recognition. Even if there is sweat or other dirt (such as hand cream or a mud stain), the ultrasonic fingerprint sensor 20 is not affected by the dirt on the finger, can accurately recognize the fingerprint, and has a better fingerprint recognition capability compared with the semiconductor fingerprint sensor.

It should be noted that, when the fingerprint sensor is disposed inside the handheld electronic device and the user uses the handheld electronic device in a situation of dim light or no light (for example, at night or in a dim room), the user cannot clearly see the handheld electronic device and has difficulty finding the fingerprint sensor accurately. Therefore, the fingerprint recognition function cannot be used well, and user experience is poor. In the handheld electronic device provided in this embodiment, the light emitting unit 30 is disposed at an adjacent location of the fingerprint sensor 20. When the user uses the handheld electronic device, the light emitting unit 30 may emit light to indicate the fingerprint sensor 20, so that the user can rapidly and accurately find the fingerprint sensor 20 in the situation of dim light or no light.

In addition, the cover 10 separates the fingerprint sensor 20 and the light emitting unit 30 from the external environment, and no through hole needs to be disposed on the cover 10 for the fingerprint sensor 20, so as to prevent water from flowing inside the electronic device through the through hole, and improve water-proof performance of the electronic device.

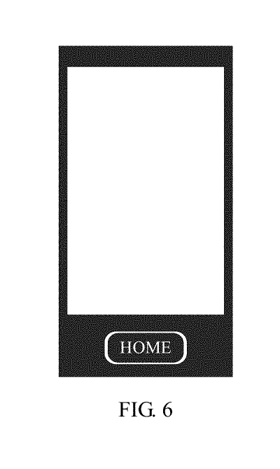

In an existing design, a single LED is usually used as an indicator to indicate various states of the handheld electronic device, for example, charging, a missed call, or an SMS message. The single LED has a limited display effect as a point light source. To implement a better display effect, based on the handheld electronic device shown in FIG. 4, this application provides a handheld electronic device with a light guide structure. FIG. 4 is a cross-section diagram of the handheld electronic device without the light guide structure. To more specifically describe a relationship between components, FIG. 5 is an exploded diagram of components of a handheld electronic device with a light guide structure. Referring to FIG. 5, the handheld electronic device in this embodiment includes:

a cover 10, a fingerprint sensor 20, and a light emitting unit 30.

A light guide structure 40 is disposed between a light transmitting area 101 and the light emitting unit 30.

The light emitting unit 30 includes at least one LED 301, and a light inlet 401 of the light guide structure 40 is disposed opposite to the LED 301. Generally, a quantity of light inlets 401 of the light guide structure is consistent with a quantity of LEDs 301. A material of the light guide structure 40 may be polymethyl methacrylate PMMA or polycarbonate (Polycarbonate, PC for short), and the PMMA is also referred to as acrylic.

In an embodiment, the light guide structure 40 is a light guide layer, and an internal surface of the light transmitting area 101 is coated with the light guide layer. When the light emitting unit 30 emits light, the light may enter the light guide structure 40 through the light inlet 401, and is guided by the light guide structure 40 and evenly emitted through the light transmitting area 101. Specifically, a shape of the light guide layer may be a ring with a handle, the handle part is used as the light inlet, and the light guide layer 103 surrounds the fingerprint sensor 20.

In another embodiment, the light guide structure 40 is a light guide sheet, and the light guide sheet fits an internal surface of the light transmitting area 101. Specifically, a shape of the light guide sheet may be a ring with a handle, the handle part is used as the light inlet, and the light guide sheet surrounds the fingerprint sensor 20. The light guide sheet may be adhered to the internal surface of the light transmitting area 101 by using a glue. In another embodiment, a groove is disposed on the internal surface of the light transmitting area 101, and the light guide sheet is adhered to a bottom of the groove by using an adhesive and fits the bottom of the groove. When the LED 301 emits light, the light enters the light guide sheet through the light inlet 401, passes through the light guide sheet, and is evenly emitted through the light transmitting area 101.

It should be noted that, in addition to the light guide layer and the light guide sheet that are shown above, the light guide structure may be a columnar light guide component, or a light guide component in another shape, and is not specifically limited herein.

It may be understood that, according to an appearance design requirement, the LED may be a white, green, red, or blue LED, and the light emitting unit 30 may use various different colors obtained by mixing various different single colors of LEDs. A manufacturer may design an LED state by means of programming. For example, effects such as a breathing light, blinking, a color change, and a marquee, a color change frequency, and color display duration may be adjusted according to different scenarios. A location of the LED may be flexibly designed according to different structures. This is not limited herein.

In another embodiment of this application, a light filter layer is disposed between the light transmitting area 101 and the light guide layer 103. The shape of the light filter layer may be a grid shape, a lattice shape, a twill shape, or another customized shape. When the light passes through the light filter layer, the light filter layer may absorb light of a specific wavelength, so as to implement display effects of different colors or different levels of luminance.

In another embodiment of this application, the light transmitting area 101 is printed with a pattern or a character. Specifically, a customized pattern or character is printed in ink in the light transmitting area, or a pattern light-transmitting area or a character light-transmitting area is disposed, and the other parts of the light transmitting area are filled with the ink. A customized pattern may be an arrow, a ring, a stripe, or the like, and a customized character may be HOME, BACK SPASE, or the like. Due to space limitation, customized patterns and characters are not enumerated. Details are not described herein.

For ease of understanding, the following describes, by using a specific application scenario, the handheld electronic device provided in this application.

A mobile phone is used as an example for the handheld electronic device. The mobile phone includes a glass cover, and the glass cover includes a display area, a light shielding area, and a light transmitting area. A customized pattern or character is printed on an internal surface of the glass cover corresponding to the light transmitting area by using a light guide material and an ink. As shown in FIG. 6, “HOME” is used as an example for the character.

An ultrasonic fingerprint sensor and a touch control button are disposed on an internal circuit card corresponding to a “HOME” button, and LEDs are separately disposed on both sides of the ultrasonic fingerprint sensor. When the LEDs emit light, the LED light may be evenly emitted through a light guide layer and the light transmitting area, and the user may observe that the “HOME” button evenly emits light. When obtaining a communications message or battery level information, the mobile phone may further adjust a blinking frequency, a display color, and display duration of the LED, so as to implement a display effect such as a breathing light, blinking, a single color, multicolor, or a marquee. Compared with an existing mobile phone, the mobile phone has better water-proof performance and dirt-repellent performance. The mobile phone includes a combination of the LED and the ultrasonic fingerprint sensor, so as to indicate a location of the ultrasonic fingerprint sensor, thereby providing convenience for the user to use the ultrasonic fingerprint sensor.

The foregoing embodiments are merely intended for describing the technical solutions of the present invention, but not for limiting the present invention. Although the present invention is described in detail with reference to the foregoing embodiments, a person of ordinary skill in the art should understand that they may still make modifications to the technical solutions described in the foregoing embodiments or make equivalent replacements to some technical features thereof, without departing from the spirit and scope of the technical solutions of the embodiments of the present invention.

1-10. (canceled)

11. A handheld electronic device, comprising:
a cover, a fingerprint sensor, and a light emitting unit, wherein the fingerprint sensor and the light emitting unit are disposed inside the handheld electronic device;
the cover comprises a light transmitting area; and
the light emitting unit is disposed opposite to the cover and is adjacent to the fingerprint sensor, so that the light emitting unit can emit light through the light transmitting area, so as to indicate a location of the fingerprint sensor.

12. The handheld electronic device according to claim 11, wherein a light guide structure is disposed between the light transmitting area and the light emitting unit; and
the light emitting unit comprises at least one light emitting diode LED, and the light guide structure comprises a light inlet disposed opposite to the at least one LED.

13. The handheld electronic device according to claim 12, wherein a material of the light guide structure is polymethyl methacrylate or polycarbonate.

14. The handheld electronic device according to claim 12, wherein a light filter layer is disposed between the light transmitting area and the light guide structure.

15. The handheld electronic device according to claim 13, wherein a light filter layer is disposed between the light transmitting area and the light guide structure.

16. The handheld electronic device according to claim 12, wherein the light guide structure is a light guide layer, and an internal surface of the light transmitting area is coated with the light guide layer.

17. The handheld electronic device according to claim 13, wherein the light guide structure is a light guide layer, and an internal surface of the light transmitting area is coated with the light guide layer.

18. The handheld electronic device according to claim 14, wherein the light guide structure is a light guide layer, and an internal surface of the light transmitting area is coated with the light guide layer.

19. The handheld electronic device according to claim 12, wherein the light guide structure is a light guide sheet, and the light guide sheet fits an internal surface of the light transmitting area.

20. The handheld electronic device according to claim 13, wherein the light guide structure is a light guide sheet, and the light guide sheet fits an internal surface of the light transmitting area.

21. The handheld electronic device according to claim 14, wherein the light guide structure is a light guide sheet, and the light guide sheet fits an internal surface of the light transmitting area.

22. The handheld electronic device according to claim 19, wherein a groove is disposed on the internal surface of the light transmitting area, and the light guide sheet is adhered to a bottom of the groove by using an adhesive.

23. The handheld electronic device according to claim 11, wherein the fingerprint sensor is an ultrasonic fingerprint sensor, a capacitive fingerprint sensor, or a radio frequency fingerprint sensor.

24. The handheld electronic device according to claim 16, wherein the fingerprint sensor is an ultrasonic fingerprint sensor, a capacitive fingerprint sensor, or a radio frequency fingerprint sensor.

25. The handheld electronic device according to claim 22, wherein the fingerprint sensor is an ultrasonic fingerprint sensor, a capacitive fingerprint sensor, or a radio frequency fingerprint sensor.

26. The handheld electronic device according to claim 11, wherein the cover is a glass cover, a sapphire cover, or a plastic cover.

27. The handheld electronic device according to claim 22, wherein the cover is a glass cover, a sapphire cover, or a plastic cover.

28. The handheld electronic device according to claim 11, wherein the light transmitting area is printed with a pattern or a character.

29. The handheld electronic device according to claim 21, wherein the light transmitting area is printed with a pattern or a character.

30. The handheld electronic device according to claim 22, wherein the light transmitting area is printed with a pattern or a character.
